(19) United States
(12) Patent Application Publication
(10) Pub. No.: US 2020/0050916 A1
(43) Pub. Date: Feb. 13, 2020

(54) Overlapping Coil Structures Formed By Folding For Compact RFID Tags

(71) Applicant: AVERY DENNISON RETAIL INFORMATION SERVICES, LLC, Mentor, OH (US)

(72) Inventor: Ian J. FORSTER, Chelmsford (GB)

(21) Appl. No.: 16/534,611

(22) Filed: Aug. 7, 2019

Related U.S. Application Data
(60) Provisional application No. 62/715,554, filed on Aug. 7, 2018.

(51) Int. Cl. G06K 19/077

(52) U.S. Cl. CPC G06K 19/07786; G06K 19/0776; G06K 19/0775

(57) ABSTRACT

RFID tags are provided with a substrate including opposing first and second surfaces each having first and second portions defined by a fold line therebetween. A conductive trace defines a first coil associated with the first portion of the first surface and a second coil associated with the second portion of the first surface. The first coil has a first number of turns, while the second coil has a second number of turns. An RFID chip is electrically coupled to the conductive trace. The substrate is folded at the fold line so as to bring the first and second portions of the first surface into facing relationship, with at least a portion of the first coil overlapping at least a portion of the second coil. The overlapping coils define an antenna having a number of turns equal to the sum of the number of turns of the two coils.

### CROSS REFERENCE TO RELATED APPLICATION(S)

The present application claims priority to and the benefit of U.S. provisional patent application No. 62/715,554 filed Aug. 7, 2018, which is incorporated herein by reference in its entirety.

### BACKGROUND

### Field of the Disclosure

The present subject matter relates to radio frequency identification (“RFID”) tags. More particularly, the present subject matter relates to compact RFID tags that are formed by folding a portion of a substrate of the RFID tag onto itself.

### Description of Related Art

RFID tags are widely used to associate an object with an identification code. RFID devices generally have a combination of antennas and analog and/or digital electronics, which may include, for example, communications electronics, data memory, and control logic. For example, RFID tags are used in conjunction with security locks in cars, for access control to buildings, and for tracking inventory and parcels. Some examples of RFID tags and labels appear in U.S. Pat. Nos. 6,107,920; 6,206,292; and 6,262,692, all of which are hereby incorporated herein by reference in their entireties.

A typical RFID tag includes an RFID chip (which may include an integrated circuit) electrically coupled to an antenna, which is capable of sending signals to and/or receiving signals from an RFID reader within range of the RFID device. The antenna is commonly formed of a conductive material (e.g., copper or aluminum) and configured as a thin, flat element, which may be formed by being printed onto a substrate (e.g., a paper or fabric or plastic material) of the RFID device.

### SUMMARY

There are several aspects of the present subject matter which may be embodied separately or together in the devices and systems described and claimed below. These aspects may be employed alone or in combination with other aspects of the subject matter described herein, and the description of these aspects together is not intended to preclude the use of these aspects separately or the claiming of such aspects separately or in different combinations as may be set forth in the claims appended hereto.

It is a general aspect of this disclosure to provide alternative approaches to configuring and tuning the antenna of an RFID tag, including a method by which a substrate is folded at a fold line so as to bring a first portion of a first surface into facing relationship with a second portion of the first surface, and a substrate including opposing first and second surfaces each having first and second portions defined by a fold line therebetween.

In one aspect, a method of manufacturing an RFID tag includes providing a generally planar substrate including opposing first and second surfaces each having first and second portions defined by a fold line therebetween. The substrate further includes a conductive trace defining a first coil associated with the first portion of the first surface and having a first number of turns and a second coil associated with the second portion of the first surface and having a second number of turns, with an RFID chip electrically coupled to the conductive trace. The substrate is folded at the fold line so as to bring the first portion of the first surface into facing relationship with the second portion of the first surface, with at least a portion of the first coil overlapping at least a portion of the second coil so as to define an antenna having a number of turns equal to the sum of the first number of turns and the second number of turns.

In a further aspect, a method of manufacturing an RFID tag includes providing a generally planar substrate including opposing first and second surfaces each having first and second portions defined by a fold line therebetween. The substrate further includes a conductive trace defining a first coil associated with the first portion of the first surface and having a first number of turns and a second coil associated with the second portion of the first surface and having a second number of turns, with an RFID chip electrically coupled to the conductive trace. The substrate is folded at the fold line so as to bring the first portion of the first surface into facing relationship with the second portion of the first surface, with at least a portion of the first coil overlapping at least a portion of the second coil so as to define an antenna having a number of turns equal to the sum of the first number of turns and the second number of turns. The method further includes connecting a first pad associated with the first coil to a second pad associated with the second coil after folding the substrate at the fold line.

In an added aspect, a method of manufacturing an RFID tag includes providing a generally planar substrate including opposing first and second surfaces each having first and second portions defined by a fold line therebetween. The substrate further includes a conductive trace defining a first coil associated with the first portion of the first surface and having a first number of turns and a second coil associated with the second portion of the first surface and having a second number of turns, with an RFID chip electrically coupled to the conductive trace. The substrate is folded at the fold line so as to bring the first portion of the first surface into facing relationship with the second portion of the first surface, with at least a portion of the first coil overlapping at least a portion of the second coil so as to define an antenna having a number of turns equal to the sum of the first number of turns and the second number of turns. The method further includes applying an uncured adhesive between the facing first and second portions of the first surface, adjusting the separation between the facing first and second portions of the first surface so as to vary at least one operational parameter of the RFID tag, and upon achieving a desired value for said at least one operational parameter, curing the adhesive so as to prevent further adjustment of the separation between the facing first and second portions of the first surface.

In an added aspect, a method of manufacturing an RFID tag includes providing a generally planar substrate including opposing first and second surfaces each having first and second portions defined by a fold line therebetween. The substrate further includes a conductive trace defining a first coil associated with the first portion of the first surface and having a first number of turns and a second coil associated with the second portion of the first surface and having a second number of turns, with an RFID chip electrically coupled to the conductive trace. The substrate is folded at the fold line so as to bring the first portion of the first surface into facing relationship with the second portion of the first surface, with at least a portion of the first coil overlapping at least a portion of the second coil so as to define an antenna having a number of turns equal to the sum of the first number of turns and the second number of turns. The method further includes providing the substrate with a second conductive trace defining a third coil associated with the first portion of the second surface, having a third number of turns, and electrically coupled through the substrate to the first coil, and a fourth coil associated with the second portion of the second surface, having a fourth number of turns, and electrically coupled through the substrate to the second coil. Folding the substrate at the fold line causes portions of the first coil, the second coil, the third coil, and the fourth coil to overlap so as to define an antenna having a number of turns equal to the sum of the first number of turns, the second number of turns, the third number of turns, and the fourth number of turns.

In another aspect, an RFID tag includes a substrate with opposing first and second surfaces each having first and second portions defined by a fold line therebetween. An antenna is associated with the first surface and defined by a conductive trace, which comprises first and second coils. The first coil is associated with the first portion of the first surface and has a first number of turns, while the second coil is associated with the second portion of the first surface and has a second number of turns. An RFID chip is electrically coupled to the antenna. The substrate is folded at the fold line so as to orient the first portion of the first surface into facing relationship with the second portion of the first surface, with at least a portion of the first coil overlapping at least a portion of the second coil such that the antenna has a number of turns equal to the sum of the first number of turns and the second number of turns.

According to another aspect, an RFID tag includes a substrate with opposing first and second surfaces each having first and second portions defined by a fold line therebetween. An antenna is associated with the first surface and defined by a conductive trace, having first and second coils. The first coil is associated with the first portion of the first surface and has a first number of turns, while the second coil is associated with the second portion of the first surface and has a second number of turns. An RFID chip is electrically coupled to the antenna. The substrate is folded at the fold line so as to orient the first portion of the first surface into facing relationship with the second portion of the first surface, with at least a portion of the first coil overlapping at least a portion of the second coil such that the antenna has a number of turns equal to the sum of the first number of turns and the second number of turns. Further, the first and second portions of the first surface are connected via an adhesive having an uncured condition in which the separation between the first and second portions of the first surface is adjustable and a cured condition in which the separation between the first and second portions of the first surface is not adjustable, and the separation between the first and second portions of the first surface is selected such that a desired value for at least one operational parameter of the RFID tag is achieved prior to curing the adhesive.

According to another aspect, an RFID tag includes a substrate with opposing first and second surfaces each having first and second portions defined by a fold line therebetween. An antenna is associated with the first surface and defined by a conductive trace, having first and second coils. The first coil is associated with the first portion of the first surface and has a first number of turns, while the second coil is associated with the second portion of the first surface and has a second number of turns. An RFID chip is electrically coupled to the antenna. The substrate is folded at the fold line so as to orient the first portion of the first surface into facing relationship with the second portion of the first surface, with at least a portion of the first coil overlapping at least a portion of the second coil such that the antenna has a number of turns equal to the sum of the first number of turns and the second number of turns. Further, a third coil is associated with the first portion of the second surface, having a third number of turns, and electrically coupled through the substrate to the first coil, and a fourth coil associated with the second portion of the second surface, having a fourth number of turns, and electrically coupled through the substrate to the second coil. Portions of the first coil, the second coil, the third coil, and the fourth coil overlap such that the antenna has a number of turns equal to the sum of the first number of turns, the second number of turns, the third number of turns, and the fourth number of turns.

### BRIEF DESCRIPTION OF THE DRAWINGS

FIG. 1 is a top plan view of an RFID tag according to aspects of the present disclosure, in an unfolded condition;

FIG. 2 is a side elevational view of the RFID tag of FIG. 1, in a folded condition;

FIGS. 3A, 3B, and 3C are end elevational views of the RFID tag of FIGS. 1 and 2, showing alternative approaches to securing the RFID tag in the folded condition of FIG. 2;

FIG. 3D is a side elevational view of another alternative approach to securing the RFID tag of FIGS. 1 and 2 in the folded condition of FIG. 2;

FIG. 4 is a top plan view of another embodiment of an RFID tag according to aspects of the present disclosure, in an unfolded condition;

FIG. 5 is a top plan view of the RFID tag of FIG. 4, in a folded condition;

FIG. 6 is a top plan view of an alternative configuration of a conductive trace defining the antenna of an RFID tag according to the present disclosure; and

FIG. 7 is a bottom plan view of another embodiment of an RFID tag according to aspects of the present disclosure, in an unfolded condition.

### DESCRIPTION OF THE ILLUSTRATED EMBODIMENTS

As required, detailed embodiments of the present disclosure are set out herein; however, it is to be understood that the disclosed embodiments are merely exemplary of the invention, which may be embodied in various forms. Therefore, specific details disclosed herein are not to be interpreted as limiting, but merely as a basis for the claims and as a representative basis for teaching one skilled in the art to variously employ the present invention in virtually any appropriate manner.

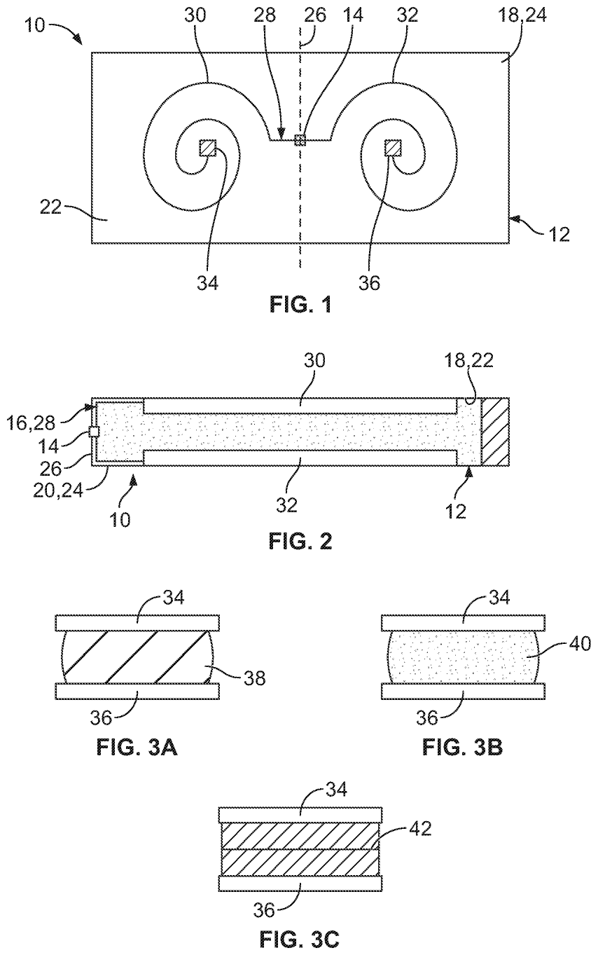

FIG. 1 shows an RFID tag 10 according to an aspect of the present disclosure, with the RFID tag 10 being in an unfolded condition. FIG. 2 shows the RFID tag 10 of FIG. 1 in a folded or final condition, which will be described in greater detail herein.

The RFID tag 10 of FIG. 1 and FIG. 2 includes a substrate 12 that is generally planar in the unfolded condition of FIG. 1. The substrate 12 is formed of a non-conductive, foldable material. The particular configuration of the substrate 12 (e.g., its surface area and thickness) and the material employed may vary without departing from the scope of the present disclosure, and may be selected based upon a number of factors related to the intended use of the RFID tag 12. For example, as shown in FIG. 2, a portion of the substrate 12 is folded onto another portion of the substrate 12, with the functional components of the RFID tag 10 (namely, an RFID chip 14 and an antenna 16) positioned between the two portions of the substrate 12, such that a principal function of the substrate 12 is supporting and protecting the functional components. In one embodiment, paper and card substrates will provide a degree of protection against impact, depending on their overall thickness (which also affects the flexibility of the formed RFID tag). In another embodiment, plastic substrates (using materials such as polyethylene terephthalate or biaxially-oriented polypropylene, for example) will provide greater protection, depending on the thickness of the substrate and the nature of the plastic, which may include protection against liquids, such as detergents and water that may come into contact with an RFID tag associated to a clothing item or the like during cleaning of the item. In yet another embodiment, fabric substrates will provide enhanced flexibility for RFID tags intended to be associated to clothing items. In another embodiment, foam substrates may provide enhanced protection against impact, depending on the foam properties. It should also be understood that the substrate may be formed of a combination of materials, which may provide additional benefits. For example, substrate formed of a combination of polyethylene terephthalate film and a foam material will result in an RFID tag with impact resistance and resistance to water ingress. It should also be understood that such flexibility in the configuration of the substrate is not limited to the embodiment of FIGS. 1 and 2, but is equally applicable to all RFID tags according to the present disclosure.

The substrate 12 (in its unfolded condition of FIG. 1) includes opposing first and second surface 18 and 20 (FIG. 2) each having first and second portions 22 and 24 defined by a fold line 26 therebetween. In the illustrated embodiment, the fold line 26 divides the substrate 12 into equally sized and shaped first and second portions 22 and 24, such that the first portion 22 will substantially perfectly overlay the second portion 24 when the substrate 12 is folded at the fold line 26 (from the unfolded condition of FIG. 1 to the folded condition of FIG. 2), but it is also within the scope of the present disclosure for a fold line 26 to define differently sized and/or shaped first and second portions. The fold line 26 may be an undistinguished or featureless section of the substrate 12 or may be provided with distinguishing characteristics, including fold line markings and/or features to improve its foldability. For example, the fold line 26 may be scored or configured or made to be thinner than other portions of the substrate 12 in order to ease and guide folding of the substrate 12 during manufacture of the RFID tag 10.

An RFID chip 14 is secured to the substrate 12. The RFID chip 14 may take any of a number of forms (including those of the type commonly referred to as a “chip” or a “strap” by one of ordinary skill in the art), including any of a number of possible components and being configured to perform any of a number of possible functions. For example, in one embodiment, the RFID chip 14 includes an integrated circuit for controlling RF communication and other functions of the RFID tag 10. In the embodiment of FIGS. 1 and 2, the RFID chip 14 is located at the fold line 26, but it is within the scope of the present disclosure for the RFID chip 14 to be located elsewhere without departing from the scope of the present disclosure. For example, in the embodiment of FIGS. 4 and 5, the RFID chip 14 is positioned away from the fold line 26, while also being positioned away from the edges of the substrate 12. In such an embodiment, the RFID chip 14 may be better protected by the substrate 12 when the RFID tag 10a is in its folded condition of FIG. 5, by being spaced away from all of the edges of the formed RFID tag 10a.

In addition to the RFID chip 14, a conductive trace 28 (FIG. 1) is also secured to (e.g., by being printed or etched onto) the substrate 12. The conductive trace 28 (which will ultimately define the antenna 16 of the RFID tag 10, as will be described in greater detail herein) is electrically coupled to the RFID chip 14 at any position along the conductive trace 28 and defines first and second spiral coils 30 and 32. The first coil 30 is associated with the first portion 22 of the first surface 18 of the substrate 12, while the second coil 32 is associated with the second portion 24 of the first surface 18 of the substrate 12.

The first coil 30 of the conductive trace 28 has a first number of turns (which may include a fraction of a turn), while the second coil 32 has a second number of turns (which may include a fraction of a turn). In the embodiment of FIGS. 1 and 2, the first and second coils 30 and 32 have the same number of turns (i.e., two turns), but it is also within the scope of the present disclosure for the first and second coils 30 and 32 to have different numbers of turns. The first coil 30 is shown as having a direction of rotation (counterclockwise, moving away from the RFID chip 14) that is opposite to the direction of rotation of the second coil 32 (clockwise, moving away from the RFID chip 14) in the unfolded condition of FIG. 1, although it is within the scope of the present disclosure for the first and second coils 30 and 32 to have the same direction of rotation in the unfolded condition. Additionally, while the first and second coils 30 and 32 are shown in FIG. 1 as being substantially the same size (thus rendering the first and second coils 30 and 32 mirror images in the unfolded condition), it should be understood that the first and second coils of a conductive trace according to the present disclosure may be differently sized, as will be described in greater detail herein.

When the substrate 12 is folded at the fold line 26 (in moving the RFID tag 10 from the unfolded condition of FIG. 1 to the folded condition of FIG. 2), the first portion 22 of the first surface 18 is brought into facing relationship with the second portion 24 of the first surface 18. It will be seen that, after folding the substrate 12 onto itself, the turns of the first and second coils 30 and 32 will have the same direction of rotation. A connection is made to retain the RFID tag 10 in its folded condition, which may include forming a connection between a first pad 34 of the first coil 30 and a second pad 36 of the second coil 32 (FIG. 1), which are brought into proximity with each other in the folded condition of FIG. 2. The connection between the pads 34 and 36 assists in retaining the RFID tag 10 in its folded condition and defining the antenna 16.

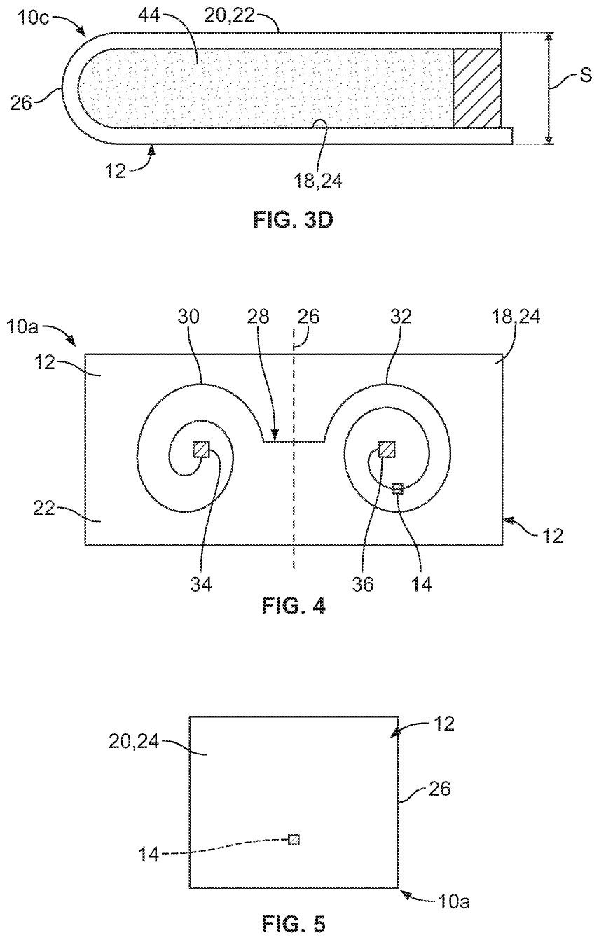

The pads 34 and 36 may be connected together to form a double-sided coil structure using any suitable mechanism. For example, the pads 34 and 36 may be connected via an isotropic or anisotropic conductive paste 38, as in FIG. 3A. In another embodiment, which is shown in FIG. 3B, the pads 34 and 36 may be connected using a non-conducting adhesive 40. In yet another embodiment, which is shown in FIG. 3C, a weld 42 (applied via laser beam-, electric resistance-, or ultrasonic-welding, for example) may be employed to connect the pads 34 and 36. Other approaches may also be employed without departing from the scope of the present disclosure.

In the folded condition, at least a portion of the first coil 30 overlaps at least a portion of the second coil 32 to define an antenna 16, which forms an inductor designed to resonate with the RFID chip 14 at the desired operational frequency. The antenna 16 effectively has a number of turns equal to the sum of the number of turns of the first coil 30 and the number of turns of the second coil 32 (which is a total of four turns in the illustrated embodiment). If the first and second coils 30 and 32 are configured as mirror images, as in the embodiment of FIGS. 1 and 2, there will be substantially complete overlap of the first and second coils 30 and 32 in the folded condition of FIG. 2. In other embodiments, there may be less than complete overlap of the first and second coils in the folded condition of the RFID tag.

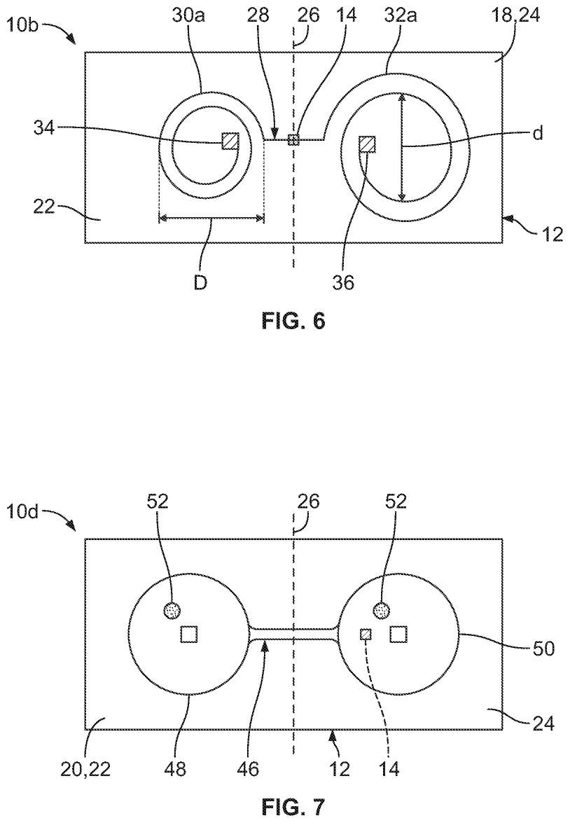

For example, an antenna formed by substantially completely overlapping coils (as in the embodiments of FIGS. 1-2 and 4-5) may result in capacitance that can, with some coil designs, reduce the performance of the antenna or affect its tuning. In such cases, it may be advantageous to reduce or even minimize the degree of overlap between the first and second coils when the RFID tag is in its folded condition. FIG. 6 shows an exemplary embodiment of such an alternative RFID tag 10b, in its unfolded condition. In the embodiment of FIG. 6, the inner diameter “d” of the second coil 32a is greater than the outer diameter D of the first coil 30a. The first and second coils 30a and 32a are configured and oriented such that, when the substrate 12 is folded at the fold line 26, the first coil 30a will be substantially positioned inside of the second coil 32a, thus decreasing the degree of overlap between the two compared to the embodiment of FIGS. 1 and 2.

FIG. 3D illustrates another alternative embodiment of an RFID tag 10c according to an aspect of the present disclosure. The RFID tag 10c of FIG. 3D may be similarly configured to the previously described embodiments, but employ a different adhesive 44 to secure the RFID tag 10b in its folded condition. More particularly, the adhesive 44 has two states—an uncured state in which it can be compressed and a cured state in which it cannot be compressed. The adhesive 44 is applied to the first surface 18 of the substrate 12 (preferably with the RFID tag 10c in its unfolded condition), with the adhesive 44 in its uncured state. With the adhesive 44 applied to the first surface 18 in its uncured state and the RFID tag 10c in its folded condition, the separation “S” between the first and second portions 22 and 24 of the first surface 18 (and, hence, the first and second coils of the conductive trace) may be adjusted by applying a variable pressure so as to vary at least one operational parameter of the RFID tag 10c. When a desired value for the operational parameter(s) has been achieved, the adhesive 44 is cured so as to prevent further adjustment of the separation “S” between the first and second portions 22 and 24 of the first surface 18.

The particular operational parameter (or parameters) that varies with separation “S” may vary without departing from the scope of the present disclosure. In one embodiment, the first and second coils are configured so that the overlap capacitance is a function of the separation “S”, such that the separation “S” may be varied to tune the frequency of the antenna. In another embodiment, the thickness of the adhesive 44 and/or its properties (such as dielectric constant) are functions of a sensed parameter, such as pressure applied to the coil structure, changing the tuned frequency and, thus, how the RFID tag 10c reads. For example, if the RFID tag 10c is designed to be read at a frequency of 13.56 MHz, the separation “S” may be varied (with the read frequency being monitored) until the RFID tag 10c is tuned to 13.56 MHz.

FIG. 7 illustrates the bottom or second surface 20 of a variation of the RFID tags described herein, in an unfolded condition. The upper or first surface of the RFID tag 10d of FIG. 7 may be configured according to any of the preceding embodiments, while the second surface 20 includes a second conductive trace 46 having a third coil 48 and a fourth coil 50. The third coil 48 is associated with the first portion 22 of the second surface 20 of the substrate 12, while the fourth coil 50 is associated with the second portion 24 of the second surface 20 of the substrate 12. The third coil 48 has a third number of turns (which may include a fraction of a turn), while the fourth coil 50 has a fourth number of turns (which may include a fraction of a turn). The third and fourth coils 48 and 50 may have the same or different numbers of turns, directions of rotation, and/or sizes. The number of turns, directions of rotation, and/or sizes of the third and fourth coils 48 and 50 may similarly be the same as or differ with respect to the corresponding characteristics of the first and second coils 48 and 50.

The third coil 48 is electrically coupled through the substrate 12 (i.e., from the second surface 20 of the substrate 12 to the first surface) to the first coil, while the fourth coil 50 is electrically coupled through the substrate 12 to the second coil. The coils on the opposing surfaces of the substrate 12 may be electrically coupled by any suitable means, which may include a crimp 52, as shown in FIG. 7.

When the substrate 12 is folded at the fold line 26 (in moving the RFID tag 10d from the unfolded condition of FIG. 7 to a final, folded condition) and the appropriate connections are made to retain the RFID tag 10d in its folded condition, portions of all four coils will overlap to define an antenna. Such an antenna is similar to the antennas of the other embodiments described herein, except that it effectively has a number of turns equal to the sum of the numbers of turns of the four coils, rather than the sum of the numbers of turns of first and second coils. This may be considered as an alternative to an embodiment in which the number of turns of an antenna is increased by increasing the number of turns of the two coils of an RFID tag having a single conductive trace, which could increase the required surface area of the substrate. Thus, an RFID tag according to the present disclosure having two conductive traces may be advantageous if an intended application requires an antenna having a large number of turns and an RFID tag having a relatively small footprint.

It will be understood that the embodiments described above are illustrative of some of the applications of the principles of the present subject matter. Numerous modifications may be made by those skilled in the art without departing from the spirit and scope of the claimed subject matter, including those combinations of features that are individually disclosed or claimed herein. For these reasons, the scope hereof is not limited to the above description but is as set forth in the following claims, and it is understood that claims may be directed to the features hereof, including as combinations of features that are individually disclosed or claimed herein.

1. A method of manufacturing an RFID tag comprising:
providing a generally planar substrate including opposing first and second surfaces each having first and second portions defined by a fold line therebetween, a conductive trace defining a first coil associated with the first portion of the first surface and having a first number of turns and a second coil associated with the second portion of the first surface and having a second number of turns, and an RFID chip electrically coupled to the conductive trace; and
folding the substrate at the fold line so as to bring the first portion of the first surface into facing relationship with the second portion of the first surface, with at least a portion of the first coil overlapping at least a portion of the second coil so as to define an antenna having a number of turns equal to the sum of the first number of turns and the second number of turns.

2. The method of claim 1, wherein the turns of the first coil have the same direction of rotation as the turns of the second coil after folding the substrate at the fold line.

3. The method of claim 1, further comprising connecting a first pad associated with the first coil to a second pad associated with the second coil after folding the substrate at the fold line.

4. The method of claim 3, wherein the first and second pads are connected via an adhesive selected from the group consisting of an isotropic conductive paste, an anisotropic conductive paste, and a non-conducting adhesive.

5. The method of claim 3, wherein the first and second pads are connected using a weld.

6. The method of claim 1, wherein the first and second coils are substantially the same size.

7. The method of claim 1, wherein an inner diameter of the second coil is greater than an outer diameter of the first coil so as to position the first coil inside of the second coil and decrease overlap of the first and second coils after folding the substrate at the fold line.

8. The method of claim 1, wherein the RFID chip is positioned away from the fold line and edges of the substrate.

9. The method of claim 1, further comprising
applying an uncured adhesive between the facing first and second portions of the first surface,
adjusting the separation between the facing first and second portions of the first surface so as to vary at least one operational parameter of the RFID tag, and
upon achieving a desired value for said at least one operational parameter, curing the adhesive so as to prevent further adjustment of the separation between the facing first and second portions of the first surface.

10. The method of claim 1, wherein the substrate includes a second conductive trace defining
a third coil associated with the first portion of the second surface, having a third number of turns, and electrically coupled through the substrate to the first coil, and
a fourth coil associated with the second portion of the second surface, having a fourth number of turns, and electrically coupled through the substrate to the second coil, wherein folding the substrate at the fold line causes portions of the first coil, the second coil, the third coil, and the fourth coil to overlap so as to define an antenna having a number of turns equal to the sum of the first number of turns, the second number of turns, the third number of turns, and the fourth number of turns.

11. An RFID tag comprising:
a substrate including opposing first and second surfaces each having first and second portions defined by a fold line therebetween;
an antenna associated with the first surface of the substrate and defined by a conductive trace comprising
a first coil associated with the first portion of the first surface and having a first number of turns, and
a second coil associated with the second portion of the first surface and having a second number of turns; and
an RFID chip electrically coupled to the antenna, wherein the substrate is folded at the fold line so as to orient the first portion of the first surface into facing relationship with the second portion of the first surface, with at least a portion of the first coil overlapping at least a portion of the second coil such that the antenna has a number of turns equal to the sum of the first number of turns and the second number of turns.

12. The RFID tag of claim 11, wherein the turns of the first coil have the same direction of rotation as the turns of the second coil.

13. The RFID tag of claim 11, further comprising a first pad associated with the first coil and connected to a second pad associated with the second coil.

14. The RFID tag of claim 13, wherein the first and second pads are connected via an adhesive selected from the group consisting of an isotropic conductive paste, an anisotropic conductive paste, and a non-conducting adhesive.

15. The RFID tag of claim 13, wherein the first and second pads are connected by a weld.

16. The RFID tag of claim 11, wherein the first and second coils are substantially the same size.

17. The RFID tag of claim 11, wherein an inner diameter of the second coil is greater than an outer diameter of the first coil so as to position the first coil inside of the second coil and decrease overlap of the first and second coils.

18. The RFID tag of claim 11, wherein the RFID chip is positioned away from the fold line and edges of the substrate.

19. The RFID tag of claim 11, wherein
the first and second portions of the first surface are connected via an adhesive having an uncured condition in which the separation between the first and second portions of the first surface is adjustable and a cured condition in which the separation between the first and second portions of the first surface is not adjustable, and
the separation between the first and second portions of the first surface is selected such that a desired value for at least one operational parameter of the RFID tag is achieved prior to curing the adhesive.

20. The RFID tag of claim 11, further comprising a second conductive trace including
a third coil associated with the first portion of the second surface, having a third number of turns, and electrically coupled through the substrate to the first coil, and
a fourth coil associated with the second portion of the second surface, having a fourth number of turns, and electrically coupled through the substrate to the second coil, wherein portions of the first coil, the second coil, the third coil, and the fourth coil overlap such that the antenna has a number of turns equal to the sum of the first number of turns, the second number of turns, the third number of turns, and the fourth number of turns.
